(19) United States
(12) Patent Application Publication
(10) Pub. No.: US 2008/0105316 A1
(43) Pub. Date: May 8, 2008

(54) Multiple fluid product stream processing

(75) Inventors: Mark Serafin, Apple Valley, MN (US); Neal K. Nelson, Stillwater, MN (US); Richard D. Olmsted, Vadnais Heights, MN (US)

Correspondence Address: Attention: Eric D. Levinson;Imation Corp., Legal Affairs, P.O. Box 64898, St. Paul, MN, 55164-0898, US

(73) Assignee: Imation Corp.

(21) Appl. No.: 11/583,761

(22) Filed: Oct. 18, 2006

(51) Int. Cl. B01F 5/04

(52) U.S. Cl. 137/896

(57) ABSTRACT

The disclosure is directed to techniques for processing multiple fluid product streams. The techniques employ multiple intensifier pump systems in combination with a fluid processing device to mix, react or otherwise combine multiple fluid product streams. The intensifier pump systems produce fluid product streams with substantially uniform pressure levels for introduction into the fluid processing device. The fluid processing device directs the multiple fluid product streams at one another via opposing flow paths, providing a dispersed phase. The intensifier pump systems include supply pumps that deliver separate fluid products at intermediate pressure levels. Charge intensifier pumps receive the separate fluid products and apply hydraulic intensification to expel the products at high pressure levels. Product intensifier pumps receive the intensified fluid products and expel them at high pressures. The supply, charge and product intensifier pumps operate in a coordinated manner to maintain a substantially uniform fluid pressures without significant pulsation.

### TECHNICAL FIELD

The disclosure relates to fluid processing and, more particularly, to processing of multiple fluid product streams.

### BACKGROUND

Hydraulic intensifier pumps are used in applications requiring delivery of a high pressure jet of fluid. An intensifier pump includes a working barrel, a hydraulic working piston, an intensifier barrel, a product intensifier piston, inlets for a hydraulic working fluid to both advance and retract the piston, an inlet for the product fluid to be pressurized, and an outlet for emission of the pressurized fluid. In operation, lower pressure hydraulic fluid is applied to the comparatively large diameter working piston. The working piston, in turn, drives the smaller diameter intensifier piston. The ratio of the hydraulic and product piston areas is the intensification ratio. The hydraulic pressure is multiplied by the intensification ratio to produce an increase in pressure.

Uniform pressure in an intensifier system can be a problem, particularly for industrial applications involving the mixing, reaction or combination of fluids to form emulsions, suspensions or solutions. As examples, intensifiers may be used for applications in which fluids are mixed, reacted or combined to form coatings, inks, paints, abrasive coatings, fertilizers, pharmaceuticals, biological products, agricultural products, foods, beverages, and the like. For some of these products, the size and uniformity of dispersed phases can be extremely important, and may be impacted by pressure fluctuation.

The total amount of energy applied to the product fluid is a function of mechanical power, shear, or extensional force, and the time that the product fluid is in the shear or force zone. In order to effectively process dispersions, the energy level must be sufficiently high and uniform to disperse agglomerated structure. Pulsation of fluid flow may produce a gradient between energy levels applied to a dispersion, however, causing a portion of the product to be subjected to insufficient processing energy. Continued processing of the product fluid, under conditions where pulsations exist, is usually inadequate to compensate for the insufficient processing resulting from the energy gradient.

### SUMMARY

The disclosure is directed to techniques for processing multiple fluid product streams. The techniques employ multiple intensifier pump sub-systems in combination with a multi-stream fluid processing device to mix, react or otherwise combine multiple fluid product streams. The intensifier pump sub-systems produce fluid product streams with substantially uniform pressure levels for introduction into the fluid processing device. The fluid processing device directs the multiple fluid product streams at one another via opposing flow paths, creating a collision that combines the fluids.

Supply pumps deliver separate fluid products at intermediate pressure levels. Charge intensifier pumps receive the separate fluid products and apply hydraulic intensification to expel the products at higher pressure levels. Product intensifier pumps receive the intensified fluid products and expel them at very high pressure levels. The supply, charge and product intensifier pumps operate in a coordinated manner to maintain substantially uniform fluid output pressures without significant pressure pulsation.

The multiple intensifier pump sub-systems may be coupled to deliver the intensified fluid products to a high pressure, multi-stream, annular fluid processing device. The annular fluid processing device defines opposing, coaxial, annular flow channels. The fluids in the two annular flow channels move in opposite directions, i.e., toward one another, and collide such that the fluids mix, react, or otherwise combine with one another. When applied to a dispersion, the shear and extensional forces generated by the collision of the fluid annuli can create a smaller, narrower size distribution of dispersed phases.

The annular fluid processing device supports mixture, reaction or combination of fluids containing one or more dispersed phases such as particulate structures. The fluid processing device reduces the size of particles or other units of microstructure in fluid mixtures and combines the mixtures to form dispersions, such as emulsions or suspensions. Alternatively, the fluid processing device may be applied to fluids that do not carry dispersed phases, e.g., to form solutions. In either case, the fluid processing device supports combination of two different fluids to form a new combined fluid product.

In one embodiment, the disclosure provides a method comprising intensifying a first fluid via a first intensifier sub-system comprising a first charge intensifier pump, a first product intensifier pump that receives a first fluid from the first charge intensifier pump via a first controllable valve, a second product intensifier pump that receives the first fluid from the first charge intensifier pump via a second controllable valve, intensifying a second fluid via a second intensifier sub-system comprising a second charge intensifier pump, a third product intensifier pump that receives a first fluid from the first charge intensifier pump via a third controllable valve, a fourth product intensifier pump that receives the first fluid from the first charge intensifier pump via a fourth controllable valve, controlling the controllable valves based on positions of pistons associated with the product intensifier pumps such that each of the controllable valves is open when the piston associated with the respective product intensifier pump is near an end of an extension cycle and closed when the piston associated with the respective product intensifier pump is at an end of a retraction cycle, and processing the first and second fluids in a fluid processing device having a first input that receives the first fluid from the first and second product intensifier pumps, a second input receives the second fluid from the third and fourth product intensifier pumps, and an output that delivers a combined product of the first and second fluids.

In another embodiment, the disclosure provides a system comprising a first intensifier sub-system comprising a first charge intensifier pump, a first product intensifier pump that receives a first fluid from the first charge intensifier pump via a first controllable valve, a second product intensifier pump that receives the first fluid from the first charge intensifier pump via a second controllable valve, a second intensifier sub-system comprising a second charge intensifier pump, a third product intensifier pump that receives a first fluid from the first charge intensifier pump via a third controllable valve, a fourth product intensifier pump that receives the first fluid from the first charge intensifier pump via a fourth controllable valve, a controller that controls the controllable valves based on positions of pistons associated with the product intensifier pumps such that each of the controllable valves is open when the piston associated with the respective product intensifier pump is near an end of an extension cycle and closed when the piston associated with the respective product intensifier pump is at an end of a retraction cycle, and a fluid processing device having a first input that receives the first fluid from the first and second product intensifier pumps, a second input receives the second fluid from the third and fourth product intensifier pumps, and an output that delivers a combined product of the first and second fluids.

The details of one or more embodiments of the disclosure are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating a multiple fluid product processing system in accordance with an embodiment of this disclosure.

FIG. 2 is a block diagram illustrating the system of FIG. 1 in greater detail.

FIG. 3 is a flow diagram illustrating operation of dual charge intensifier pumps in the system of FIGS. 1 and 2.

FIG. 4 is a flow diagram illustrating the operation of dual product intensifier sub-systems in the system of FIGS. 1 and 2.

FIG. 5 is a cross-sectional diagram of a fluid processing device having an annular fluid flow channel for use with the system of FIGS. 1 and 2.

### DETAILED DESCRIPTION

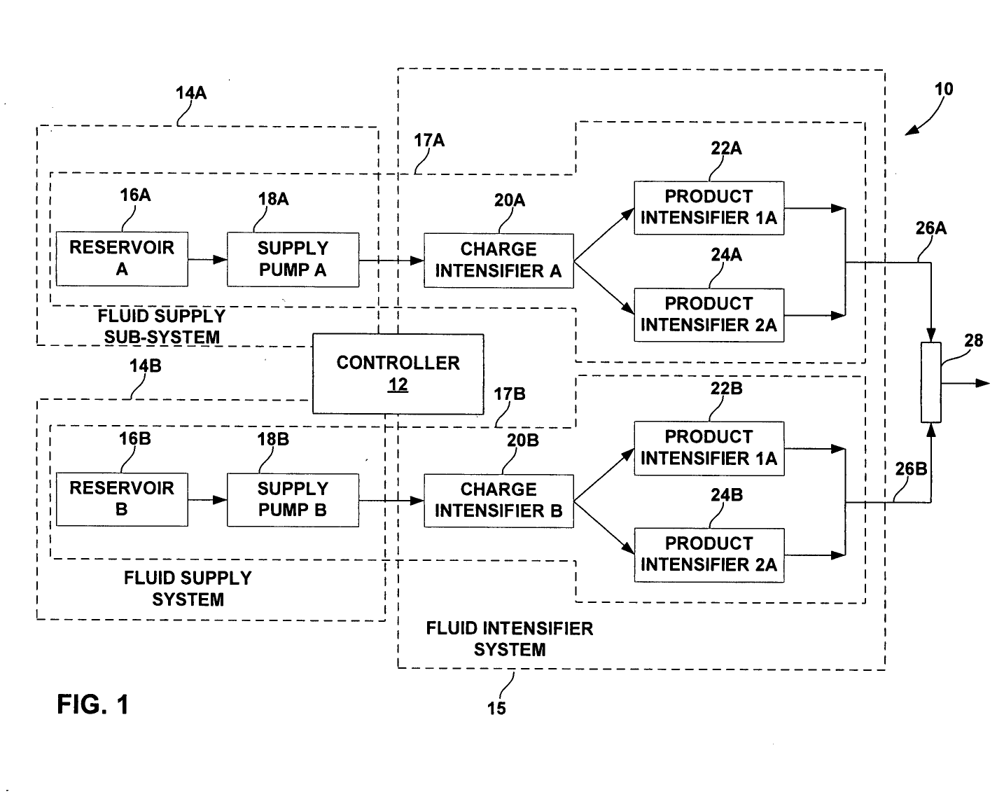

FIG. 1 is a block diagram illustrating a multiple fluid product processing system 10 in accordance with an embodiment of this disclosure. In the example of FIG. 1, system 10 includes dual intensifier sub-systems, each of which pressurizes a different fluid product for combination in a multi-stream fluid processing device. As shown in FIG. 1, system 10 includes a controller 12, a first fluid supply sub-system 14A, a second fluid supply sub-system 14B, and a fluid intensifier system 15. Controller 12 controls the operation of fluid supply sub-systems 14A, 14B and fluid intensifier system 15 to produce high pressure streams of fluid for combination in fluid processing device 28.

Each fluid sub-system 14A, 14B includes a respective fluid reservoir 16A, 16B. Reservoirs 16A, 16B store different fluid products. Supply pump 18A delivers fluid from reservoir 16A, within one fluid product intensifier sub-system 17A, formed by reservoir 16A, supply pump 18A, charge intensifier 20A, product intensifier 22A and product intensifier 24A. Supply pump 18B delivers fluid from reservoir 16B to another fluid product intensifier sub-system 17B, formed by reservoir 16B, supply pump 18B, charge intensifier 20B, product intensifier 22B, and product intensifier 24B. Controller 12 generates instructions to control the operation of supply pumps 18A, 18B.

Charge intensifier pumps 20A, 20B operate as dual charge intensifiers, providing different product fluids at elevated pressures. Product intensifier pumps 22A, 24A form a first set of dual product intensifiers, while product intensifier pumps 22B, 24B form a second set of dual product intensifiers. Product intensifiers 22A, 24A operate in a coordinated manner, in response to controller 12, to deliver a high pressure stream of fluid 26A to fluid processing device 28. Likewise, in response to controller 12, product intensifiers 22B, 24B operate in a coordinated manner to deliver a high pressure stream of fluid 26B to fluid processing device 28. Fluid processing device 28 receives the high pressure streams of fluid 26A, 26B and combines them. In particular, fluid processing device 28 may include opposing, annular, coaxial flow paths, each of which carries one of the high pressure streams of fluid 26A, 26B. The fluid streams 26A, 26B collide as the annular flow paths meet, resulting in mixture, reaction, or combination of the fluids.

As will be described, system 10 may include various sensors, actuators, controllable valves and check valves to control flow and pressurization of fluid. In general, intensifier system 15 gains efficiencies through the use of charge intensifier pumps 20A, 20B, which deliver streams of fluid under a relatively high pressure to product intensifier pumps 22A, 24A and product intensifier pumps 22B, 24B, respectively. Each charge intensifier pump 20A, 20B functions at a pressure level sufficient to cause a piston in a receiving product intensifier 22A, 24A or 22B, 24B pump to retract, thus allowing the product intensifier pump barrel to fill with product. After filling, the respective charge intensifier pump 22A, 24A or 22B, 24B can continue to increase the pressure within the filled product intensifier pump barrel, thus reducing the amount of preloading required by the product intensifier pump prior to beginning its advance cycle.

Product intensifier pumps 22A, 24A may be configured so that they are at least partially out of phase with one another. In particular, product intensifier pumps 22A, 24A may be controlled by controller 12 so that one is advancing (and hence delivering product) while the other is retracting and preloading. However, the retraction cycles of each set of product intensifier pumps 22A, 24A or 22B, 24B may at least partially overlap. During the retraction of a product intensifier pump 22A, 24A, it is being filled with product so that, during a subsequent advance stroke, fluid is expelled. Each one of intensifier sub-systems 17A, 17B may conform substantially to the intensifier system described in U.S. Pat. No. 6,558,134, issued May 6, 2003, to Serafin et al., the entire content of which is incorporated herein by reference.

As described in the above-referenced '134 patent, at the end of an advance cycle, fluid is allowed to enter product intensifier pump 22A or 24A from charge intensifier pump 20A. The fluid is delivered at a relatively high pressure that is sufficient to cause a piston in the product intensifier pump 22A or 24A to retract at a relatively high speed. Thus, the charge intensifier pump 20A can increase the speed of the retraction stroke of the product intensifier pump 22A or 24A. The charge intensifier pump 20A may have a larger product displacement per stroke than that of the product intensifier pumps 22A, 24A. Thus, the charge intensifier pump 20A fully fills one of the product intensifier pumps 22A, 24A with each stroke. In addition, the charge intensifier pump 20A fills the product intensifier pumps 22A, 24A without introducing air, thus aiding in the control and elimination of pulsation.

Even after fully retracting, fluid is still delivered from the charge intensifier pump 20A to the barrel of one of the product intensifier pumps 22A, 24A, causing the fluid within the respective product intensifier pump to further increase in pressure. This reduces the amount of time the product intensifier pump 22A, 24A will need to preload or precompress the material before the advance stroke begins to deliver the fluid product. The product intensifier pump 22A, 24A then begins its advance cycle, delivering fluid product. At or near the same time, the other product intensifier pump 22A, 24A is retracted by the delivery of product from the charge intensifier pump 20A. In this manner, material is substantially constantly and consistently delivered by the product intensifier pumps 22A, 24A, which operate at least partially out of phase with one another.

The pistons in product intensifier pumps 22A, 24A are retracted quickly with the aid of the charge intensifier pump 20A. The preload period is greatly reduced. Thus, efficiency is increased through a reduction in the required time duration for each cycle. Further, because the charge intensifier pump 20A causes the retraction of each of the product intensifier pumps 22A, 24A, there is no need to provide a hydraulic retraction cycle for any of the product intensifier pumps. Rather, in some embodiments, the hardware and fittings necessary for delivery of working fluid for retraction can be eliminated. Thus, the complexity of the product intensifier pumps 22A, 24A is reduced, making them more efficient and cost effective. Charge intensifier pump 20B and product intensifier pumps 22B, 24B may operate in a substantially identical manner as that described above with respect to charge intensifier pump 20A and product intensifier pumps 22A, 24A.

Combining charge intensifier pumps 20A, 20B and product intensifier pumps 22A, 24A, 22B, 24B in parallel enables delivery of multiple fluids to fluid processing device 28 with precise pressure levels. The fluid products are delivered, separately, to two independent intermediate intensifier pumps that take advantage of hydraulic intensification to expel the products at high pressures to assure continuous product deployment in various systems. The separate products are delivered from the charge intensifier pumps 20A, 20B at pressures sufficient to increase the retract speed of the separate, product intensifier pumps 22A, 24A, 22B, 24B and fill the intensifier barrels with the two different fluids.

Charge intensifier pumps 20A, 20B ensure the filling of the product intensifier barrels without introduction of air. In addition, charge intensifier pumps 20A, 20B produce an elevated pressure in the separate product fluids within the product intensifier pumps 22A, 24A, 22B, 24B during the end of the retract cycle, thus reducing the amount of preload time required. The product intensifiers 22A, 24A, 22B, 24B subsequently expel the two separate products, simultaneously at very high pressures, e.g., in a range of approximately 5,500 to 40,000 pounds per square inch (psi) (approximately 38 megapascals to 275 megapascals), without significant pressure pulsation. In this disclosure, in the event of any disagreement between the values for psi and megapascals, the values expressed in psi will govern.

Controller 12 processes sensor signals indicating the state or position of operation of each charge intensifier pump 20A, 20B and product intensifier pump 22A, 24A, 22B, 24B, and actuates various valves to control the operation of the pumps. As will be described, various sensors can be positioned to allow controller 12 to determine the positions of each of the pistons in the product intensifier pumps 22A, 24A, 22B, 24B and the charge intensifier pumps 20A, 20B. Controller 12 actively controls the functioning of a number of valves located throughout the system, which may be referred to herein as “smart” valves.

An example of a suitable valve is disclosed in U.S. Pat. No. 6,328,542, issued Dec. 11, 2001, to Serafin et al., the entire content of which is incorporated herein by reference. Use of a smart valve is also described in the above-referenced '134 patent. In general, smart valves are actively controllable valves that can be opened and closed through the use of an actuator that is coupled with the controller 12. The actuator may be an air cylinder, solenoid or other actuating mechanism. Controller 12 can determine, based on sensor data, when a particular intensifier pump is at or near the end of an extension or retraction cycle. Controller 12 can then control an actuator to open or close the appropriate smart valve or valves in anticipation of the completion of this cycle.

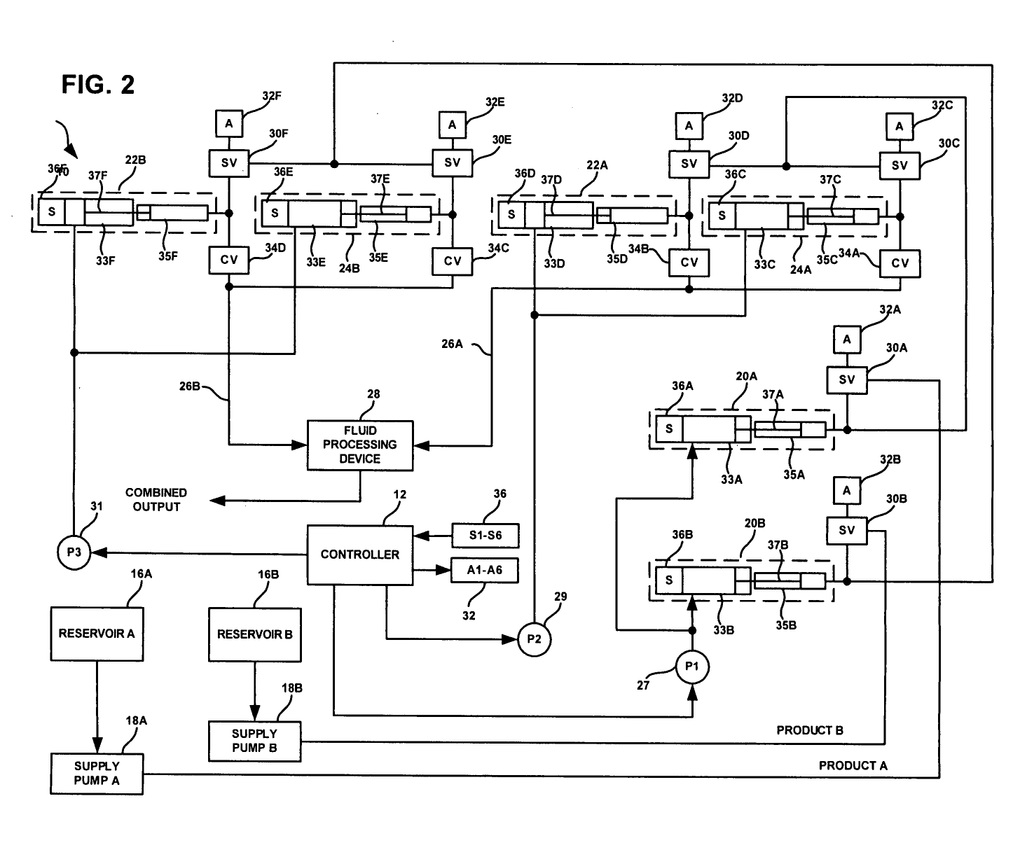

FIG. 2 is a block diagram illustrating system 10 of FIG. 1 in greater detail. FIG. 2 shows controller 12, reservoirs 16A, 16B, supply pumps 18A, 18B, charge intensifier pumps 20A, 20B, product intensifier pumps 22A, 24A, 22B, 24B, and fluid processing device 28, which may be a multi-stream annulus processor. In addition, FIG. 2 shows a pump (P1) 27 that delivers hydraulic working fluid to charge intensifier pumps 20A, 20B. In addition, pump 29 delivers hydraulic working fluid to product intensifier pumps 22A, 24A, and pump 31 delivers hydraulic working fluid to product intensifier pumps 22B, 24B. Controller 12 controls the operation of pumps 27, 29 and 31.

Each intensifier pump 20, 22, 24 includes a working barrel and an intensifier barrel. For example, charge intensifier pump 20A includes a larger diameter working barrel 33A with a working piston, and a smaller diameter intensifier barrel 35A with an intensifier piston. The piston 37A in working barrel 33A is driven forward by hydraulic fluid. In turn, the working piston drives the product piston in intensifier barrel 35A forward to expel product fluid. Similarly, product intensifier pump 24A includes a larger diameter working barrel 33C with a piston 37C that is driven forward by hydraulic fluid. In turn, the working piston drives the product piston in intensifier barrel 35C of product intensifier pump 24A forward to expel product fluid 26A at an elevated pressure for delivery to fluid processing device 28. Similar arrangements are provided for intensifier pumps 20B, 22A, 22B, 24B.

As further shown in FIG. 2, each intensifier pump 20A, 20B, 22A, 24A, 22B, 24B also includes a sensor (S) 36A-36F. Each sensor 36 may be formed by a linear position transducer (LPT), linear variable displacement transducer (LVDT), limit switch, proximity switch, or other sensor capable of provide an indication of the position of the working piston to controller 12. In the example of FIG. 2, system 10 also includes a set of actuators (A) 32A-32F and smart valves (SV) 30A-30F. Actuators 32 open and close respective smart valves 30, in response to control signals from controller 12, to control flow of product fluid into the intensifier barrels of the respective intensifier pumps 20, 22, 24.

In addition, product intensifier pumps 22A, 24A, 22B, 24B each include a respective check valve (CV) 34A-34D between the output of the intensifier product barrel and fluid processing device 28. Each CV 34A-34D is a passive one-way valve that prevents backflow into one pump (e.g., 22A) when the other pump (e.g., 22B) in the pair is expelling fluid at high pressure. Controller 12 receives sensor signals (S1-S6) from sensors 36A-36F, as indicated by block 36 in FIG. 2. In response to the sensor signals, controller 12 generates control signals (A1-A6) to control actuators 32A-32B and thereby control the operation of intensifier pumps 20, 22, 24, as indicated by block 32. In particular, controller 12 controls the timing during which product fluid is introduced into the intensifier barrels of the intensifier pumps 20, 22, 24.

Reservoirs 16A, 16B store different fluid products, such as any combination of dissimilar liquids and/or liquid/solid mixtures, including chemicals, dispersions, solvents, emulsions and liposomes. The fluids in reservoirs 16A, 16B may have different solid contents, agglomerations, and different types of dispersed phases, such as hard particles. In some applications, at least one of the fluids in reservoirs 16A, 16B may be an aqueous solution. In operation, fluids from reservoirs 16A, 16B enter the intensifying system via supply pumps 18A, 18B, respectively. Each supply pump 18A, 18B may be a diaphragm pump capable of delivering fluid at approximately 60-100 psi (approximately 0.4 megapascals to 0.7 megapascals). This pressure may be varied from application to application depending on system design and the types of fluid carried.

Supply pump 18A feeds the first fluid product from reservoir 16A to smart valve 30A, which functions as a controllable check valve that can be actively opened and closed by an actuator 32A, under control by controller 12, as described above. Smart valves 30A-30F, actuators 32A-32F, sensors 36A-36F, pumps 27, 29, 31, and controller 12 collectively form a control system for fluid processing system 10. Smart valve 30A controls flow of product fluid into the intensifier barrel of charge intensifier pump 20A. When smart valve 30A is opened, the product fluid from supply pump 18A is allowed to fill the intensifier barrel 35A of charge intensifier pump 20A. When smart valve 30A is closed, the product fluid cannot enter intensifier barrel 35A. At the same time, when smart valve 30A is closed, product fluid expelled from intensifier barrel 35A cannot backflow through the smart valve. The product fluid is pressurized to a sufficient level to drive the intensifier piston 37A within charge intensifier pump 20A backwards, such that the intensifier barrel 35A is filled with the product fluid.

Upon receiving the fluid, a piston within charge intensifier pump 30A advances under hydraulic pressure produced by pump 27, expelling the product fluid at an intermediate pressure, e.g., in the range of approximately 700-2000 psi (approximately 4.8 megapascals to 13.8 megapascals). In particular, hydraulic fluid provided by pump 27 fills the working barrel 33A and drive the piston forward in the intensifier barrel 35A to expel the product fluid. At this point, smart valve 30A is closed and functions as a check valve to prevent backflow of product fluid toward supply pump 18A. The product fluid is transmitted to smart valves 30C, 30D for introduction into the product barrels 35C, 35D of product intensifier pumps 24A, 22A, respectively.

Although the operation of charge intensifier pump 18A has been described above, charge intensifier pump 18B may function in similar way. In particular, charge intensifier pump 18B receives product fluid in intensifier barrel 35B from supply pump 18B when controller 12 controls actuator 32B to open smart valve 30B. Hydraulic fluid introduced into working barrel 33B by pump 27 drives the piston 37B forward to expel the product fluid out of intensifier barrel 35B at an increased pressure. Like charge intensifier pump 20A, charge intensifier pump 20B transmits the resulting product fluid to a pair of product intensifier pumps, in this case product intensifier pumps 22B, 24B via smart valves 30F, 30E, respectively.

In each case, the product fluid arriving at the respective product intensifier pumps 22A, 24A and 22B, 24B arrive at a substantially increased pressure relative to the pressure provided by supply pumps 18A, 18B due to the additional pressurization provided by a respective charge intensifier pump 20A, 20B. The pressurized fluid, e.g., in a range of approximately 700-2000 psi (approximately 4.8 megapascals to 13.8 megapascals), passes through the open smart valve 30 and has sufficient force to retract the piston in the product intensifier barrel 35 at a relatively high speed and subsequently fully fill the product intensifier barrel. Notably, the charge intensifier pump 20A, 20B fills the intensifier barrel 35 of the respective product intensifier pump 22, 24 without introducing air into the barrel. Also, as the charge intensifier pump 20 continues to deliver pressurized product fluid to the intensifier barrel 35, the product fluid is effectively preloaded. At the culmination of the process, the respective smart valve 30 is closed by actuator 32, under control by controller 12, preventing backflow of product fluid.

Controller 12 determines whether to open and close the various smart valves 30 based on the positions of the respective pistons 37A-37F of the associated intensifier pumps 20, 22, 24. Sensors 36A-36F may be placed at the ends of the hydraulic pistons in charge intensifier pumps 20A, 20B and product intensifier pumps 22A, 24A, 22B, 24B,.or elsewhere, to sense the positions of the pistons and transmit the information to controller 12. In charge intensifier pump 20A, for example, when the respective piston is at or near the end of a retraction cycle, controller 12 closes smart valve 30A to stop the fluid flow from supply pump 18A to the charge intensifier barrel 35A.

At approximately the same time, controller 12 controls hydraulic pump 27 to pump hydraulic fluid to working barrel 33A under pressure to drive the piston forward within intensifier barrel 35A and thereby expel the fluid to one of the product intensifier pumps 22A, 24A. Product intensifier pumps 22A, 24A operate at least partially out of phase to receive product fluid at different times. Hence, the piston 37D in first product intensifier pump 22A is generally in a retracted position when the piston 37C in second product intensifier pump 24A is at or near the end of an extension cycle. Similarly, the-piston 37D in product intensifier pump 22A is in an extended position when the piston 37C in product intensifier pump 24A is in a retracted position. To facilitate preloading, however, the retraction cycles of each pair of product intensifier pumps 22A, 24A or 22B, 24B may overlap for a limited period of time.

Product intensifier pumps 22B, 24B operate in a similar manner, providing out-of-phase intensification of product fluid received from charge intensifier pump 20B. In this way, each pump in a respective pair of product intensifiers pumps 22A, 24A or 22B, 24B operates out of phase with the other pump in the pair to provide a combined output that is substantially continuous and constant. Product intensifier pumps 22A, 24A receive hydraulic working fluid within working barrels 33D, 33C from pump 29, while product intensifier pumps 22B, 24B receiving hydraulic working barrels 33F, 33E from pump 31. Controller 12 controls the operation of pumps 27, 29, and 31 in response to sensor signals received from sensors 36A-36F, and also control actuators 32A-32F in coordination with pumps 27, 29, and 31 to control the opening and closing of smart valves 30A-30F.

Product intensifier pumps 22A, 24A, 22B, 24B may include substantially the same components as those of charge intensifier pumps 20A, 20B. For example, each product intensifier pump 22A, 24A, 22B, 24B includes a respective piston 37C-37F that includes working surfaces within working barrel 33C-33F and intensifier barrel 35C-35F. In this manner, hydraulic fluid injected into working barrel 33C-33F drives the working surface of the piston forward to expel fluid from intensifier barrel 35C-35F during an advance cycle. Similarly, injection of product fluid into intensifier barrel 35C-35F drives the working surface of the piston backwards during a retraction cycle. Each piston 37C-37F is described as a unitary piston having surfaces in the working barrel 33C-33F and intensifier barrel 35C-35F. In some embodiments, however, each piston may include a working piston in working barrel 33C-33F and a separate intensifier piston in intensifier barrel 35A-35F, and the working and intensifier pistons may be coupled together, e.g., by a rod or other coupling member.

A sensor 36C-36F is mounted with each product intensifier pump 22A, 24A, 22B, 24B to sense the position of the piston 37C-37F within the working barrel 33C-33F and/or intensifier barrel 35C-35F, and transmit the sensed position to controller 12. Again, each sensor 36 may be formed by a linear position transducer (LPT), linear variable displacement transducer (LVDT), limit switch, proximity switch, or other sensor capable of providing an indication of the position of the piston to controller 12. Controller 12 uses the position information to actuate various smart valves 30C-30F via actuators 32C-32F and control pumps 29, 30, 31, and thereby allow the pressurized product fluid to flow from the appropriate charge intensifier pump 20A, 20B to the appropriate product intensifier pump 22A, 24A, 22B, 24B.

With reference to a first pair of product intensifier pumps 22A, 24A, when intensifier piston 37C in pump 24A reaches the end of its advance/extension cycle, information indicative of this position is sent by sensor (S) 36C to controller 12. Controller 12 then controls actuator 32C to cause smart valve 30 to open. At the same time, controller 12 activates pump 27 to inject hydraulic working fluid into working barrel 33A of charge intensifier pump 20A, and controls actuator 32A to close smart valve 30A, causing pressurized product fluid to be expelled from intensifier barrel 35A and injected into intensifier barrel 35C of product intensifier pump 24A. In response, piston 37C retracts. When sensor 36C indicates that piston 37C has reached a point of full retraction, controller 12 delays the advance cycle for a short period of time to permit preloading of the piston 37C. Controller 12 then activates pump 29 to inject hydraulic working fluid into working barrel 33C to drive piston 37C forward. At the same time, controller 12 closes smart valve 30C. As piston 37C advances within intensifier barrel 35C, fluid is expelled through one-way check valve (CV) 34A and into fluid processing device 28.

While piston 37C of product intensifier pump 24A is advancing, controller 12 actuates smart valve 30D so that intensifier barrel 35D of product intensifier pump 22A is filled with product fluid from charge intensifier pump 20A, thereby retracting piston 37D. Because the fluid is delivered at high pressure, e.g., at approximately 800-1200 psi, piston 37D is forced to retract backward at a relatively high speed, eliminating the need to provide a mechanism to hydraulically retract the piston. Once piston 37C has partially advanced and piston 37D has fully retracted, as indicated by position sensors 36D and 36C, controller 12 closes smart valve 30D and injects hydraulic working fluid into working barrel 33D to drive piston 37D forward and thereby expel product fluid from intensifier barrel 35D at a high pressure. The high pressure product fluid flows through check value 34B to fluid processing device 28. Check valve 34A transmits flow in only one direction, toward fluid processing device 28, preventing backflow of pressurized fluid into product intensifier pump 24A.

Charge intensifiers 20A, 20B may be constructed to have a larger product displacement per stroke than that of product intensifiers 22A, 24A, 22B, 24B. Therefore, charge intensifiers 20A, 20B may be capable of fully filling intensifier barrels 37C-37F with each respective advance stroke. In addition, charge intensifiers 20A, 20B fill intensifier barrels 37C-37F without introducing air, thus aiding in the control and elimination of pulsation in the output flow.

As mentioned above, controller 12 may be configured so that it does not immediately close smart valve 30D upon full retraction of piston 37D of intensifier pump 22A. Likewise, controller 12 may operate in the same way for intensifier pumps 24A, 22B, and 24B. Instead of immediately closing respective smart valves 30C-30F upon full retraction, controller 12 may allow the smart valves to remain open for a period of time to permit continued preloading. As the fluid continues to be delivered by charge intensifier 20A or 20B, the pressure within the respective product intensifier barrel 35C-35F continues to increase, e.g., to approximately 1600-1700 psi (approximately 11.0 to 11.7 megapascals). At an appropriate time or set point, controller 12 then closes the respective smart valve 30C-30D to shut off the fluid supply, and prevent any backflow. Also, at about the same time that the smart valve is closed, controller 12 activates pump 29 or 31, as applicable, to supply hydraulic working fluid to the respective product intensifier pump 22A, 24A, 22B, 24B, causing the respective piston 37C-37F to advance.

As piston 37C-37F advances, it forces the fluid through check valve 34A-34D at a very high pressure, e.g., approximately 40,000 psi (275 megapascals). As the piston 37C-37F reaches the end of its extension cycle, controller 12 again opens smart valve 30C-30F and the process is repeated. Hence, the advance and retract cycles of each pair of charge intensifier pumps 20A, 20B, product intensifier pumps 22A, 24A and 22B, 24B operate generally out of phase with one another, but may have a slight overlap. For example, product intensifier pump 22A advances while product intensifier pump 24A retracts, and vice versa. However, there may be a relatively short period during which product intensifier pump 24A remains retracted while product intensifier pump 22A begins to retract, providing a preloading interval. The alternating operation of the pumps in each pair of pumps may be similar to that described in the above-referenced '134 patent.

While charge intensifier pump 20A is supplying fluid to the first pair of product intensifier pumps 22A, 24A, and those pumps are operating out-of-phase with one another to deliver highly pressurized product fluid to fluid processing device 28, charge intensifier pump 20B and the second pair of product intensifier pumps 22B, 24B are operating in the same manner. However, the intensifier sub-system formed by charge intensifier pump 20A, product intensifier pump 22A, and product intensifier pump 24A delivers a different fluid than the intensifier sub-system formed by charge intensifier pump 20B, product intensifier pump 22B, and product intensifier pump 24B. In this manner, system 10 supports supply of two different fluids to fluid processing device 28 for mixing, reacting, combining, or other processing of the fluids. In some embodiments, system 10 may include additional intensifier sub-systems similar or identical to those shown in FIG. 2 to deliver additional fluids such that the system can support processing of two or more fluids. In each manner, consistent delivery of multiple intensified product fluids can be achieved to support a variety of multiple fluid product stream applications.

Controller 12 may be formed by a single centralized controller, or a plurality of parallel or distributed controllers. For example, in some embodiments, each intensifier pump may include its own controller, linked to a respective sensor and smart valve. For synchronized delivery, however, a single controller 12 may be desirable. Controller 12 may be realized by any combination of one or more microprocessors, microcontrollers, application specific integrated circuits (ASICs), field programmable gate arrays (FPGAs), or the like, and may include hardware, software, firmware, or any combination of such components.

Controller 12 controls smart valves 30A-30C and pumps 27, 29, 31 in response to piston position signals provided by sensors 36A-36F to ensure precise and coordinated operation of the various intensifier pumps. In addition to position sensors, controller 12 also may receive sensed pressure levels from pressure sensors placed in various flow lines throughout system 10. The pressure of the intensified fluids in the output lines leading to fluid processing device 28 may be in a range of approximately 5,500 to 40,000 psi (approximately 38 megapascals to 275 megapascals). Upon exiting fluid processing device 28, the fluid is then delivered downstream to be utilized in any appropriate process. For example, in the case of magnetic particle dispersions, the resulting fluid may be used to coat disk or tape media.

Pump 27 may be selected to have sufficient power to inject hydraulic fluid into both charge intensifier pump 20A and charge intensifier pump 20B at substantially the same time. In this manner, charge intensifier pumps 20A, 20B may advance and retract simultaneously to deliver pressurized product fluid at substantially the same time. In other embodiments, charge intensifier pumps 20A, 20B may operate out of phase with one another, such that one intensifier pump 20A, 20B advances while the other intensifier pump retracts or is in a retracted position. In this case, additional valve hardware may be added to selectively fill with working barrels 33A, 33B of one of the charge intensifier pumps 20A, 20B at a given time. In many applications, however, simultaneous deliver of fluid by charge intensifier pumps 20A, 20B may be desirable, either by using a common pump 27 or two pumps operating in unison.

Pumps 29, 31 deliver sufficiently pressurized hydraulic fluid to advance first product intensifier pumps 22A, 24A and second product intensifier pumps 22B, 24B, respectively, on a time cycle that the advance and retract cycles of the pumps in each pair is either completely or partially out of phase with one another. For example, as product intensifier pump 22A retracts and preloads, product intensifier pump 24A advances, and vice versa, in response to fluid delivered by pump 29 and selective actuation of smart valves 30C, 30D. Similarly, as product intensifier pump 22B retracts and preloads, product intensifier pump 24B advances, and vice versa, in response to fluid delivered by pump 31 and selective actuation of smart valves 30E, 30F.

When product intensifier pump 22A operates partially out of phase with product intensifier pump 24A, there also may be a slight overlap in the advancing cycle such that that is there is a short period in which both product intensifier pumps 22A, 24A are in the advancing cycle. For example, when the product intensifier pump 24A is near the end of the advancing phase or is almost fully extended, product intensifier pump 22A has already started to begin its advancing phase. This overlapping operation assures a consistent and uniform material output. Again, multiple hydraulic fluid pumps may be used to supply hydraulic fluid to each pair of product intensifier pumps 22A, 24A and 22B, 24B. However, a single pump for each pump 22A, 24A or 22B, 24B may be preferred.

In some embodiments, pumps 27, 29, 31 may be powered by a single, common electric motor. With the same single motor and single power source, pumps 27, 29, 31 may operate consistently without significant variation in energy/power fluctuation from pump to pump. Therefore, whether the system is used as a delivery system of multiple fluid streams or as a mixing system utilizing its high pressure and high velocity product outputs, the use of the single motor to power the hydraulic fluid pumps 27, 29, 31 contributes to substantially pulse-free operation.

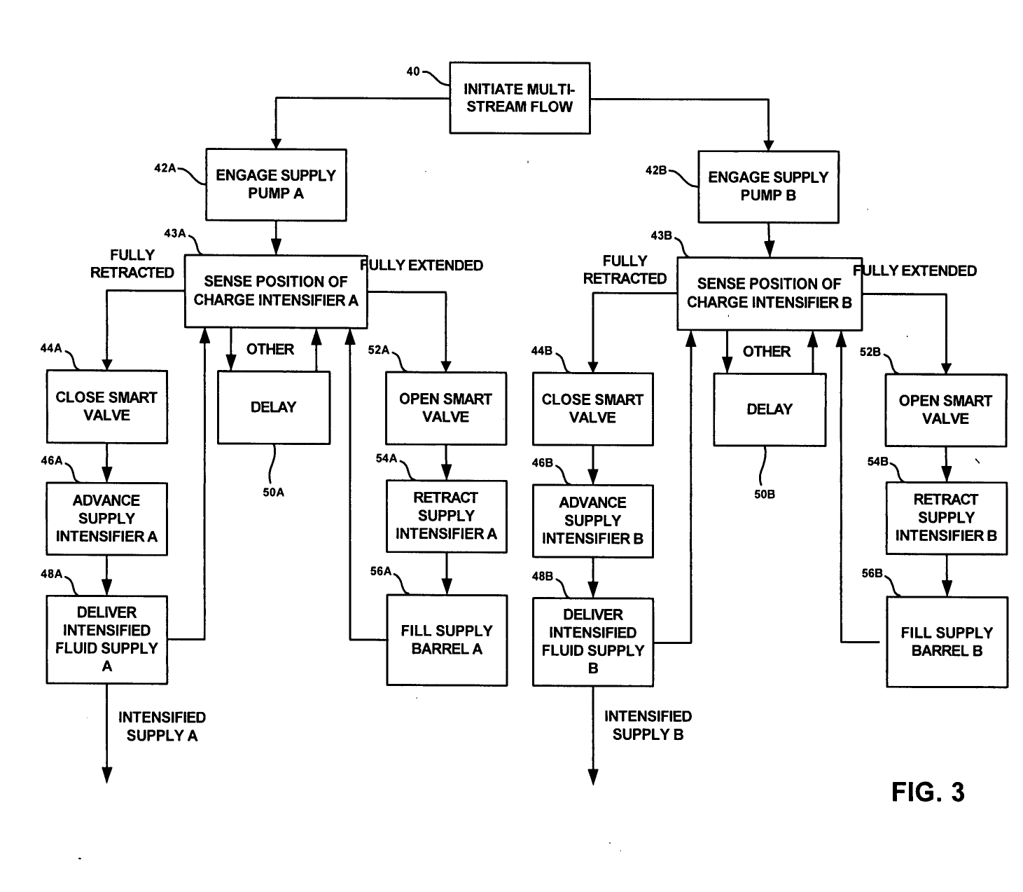

FIG. 3 is a flow diagram illustrating operation of dual charge intensifier pumps 20A, 20B in the system 10 of FIGS. 1 and 2. As shown in FIG. 3, upon initiation of multi-stream flow (40), controller 12 engages supply pump 18A (42A) and supply pump 18B (42B) to deliver product fluid to charge intensifier pumps 20A, 20B, respectively. Controller senses the positions of the pistons in charge intensifier pumps 20A, 20B (43A, 43B) via the various position sensors 36A, 36B. If the piston in the charge intensifier pump 20A, 20B is fully retracted, controller 12 closes the associated smart valve 30A, 30B (44A, 44B), and applies the hydraulic fluid pump 27 to advance the piston in respective charge intensifier pump (46A, 46B). As the piston advances, the respective charge intensifier pump 20A, 2B delivers intensified fluid (48A, 48B). (00561 If the piston in the charge intensifier pump 20A, 20B is fully extended, controller 12 opens the pertinent smart valve 30A, 30B (52A, 52B) to allow the respective supply pump 18A, 18B to deliver product fluid to the intensifier barrel 35A, 35B or the respective charge intensifier pump 20A, 20B and thereby retract the intensifier piston (54A, 54B), thereby filling the intensifier barrel (56A, 56B). If the piston is not full retracted or fully extended, controller 12 waits for a delay period (50A, 50B) to receive the next position indication from sensors 36A, 36B. Position signals may be provided by sensors 36A, 36B on a continuous, periodic basis, or only when the piston reaches a predetermined position. The actuation of smart valves 30A, 30B and activation of pump 27 may be controlled on a coordinated or independent basis by controller 12.

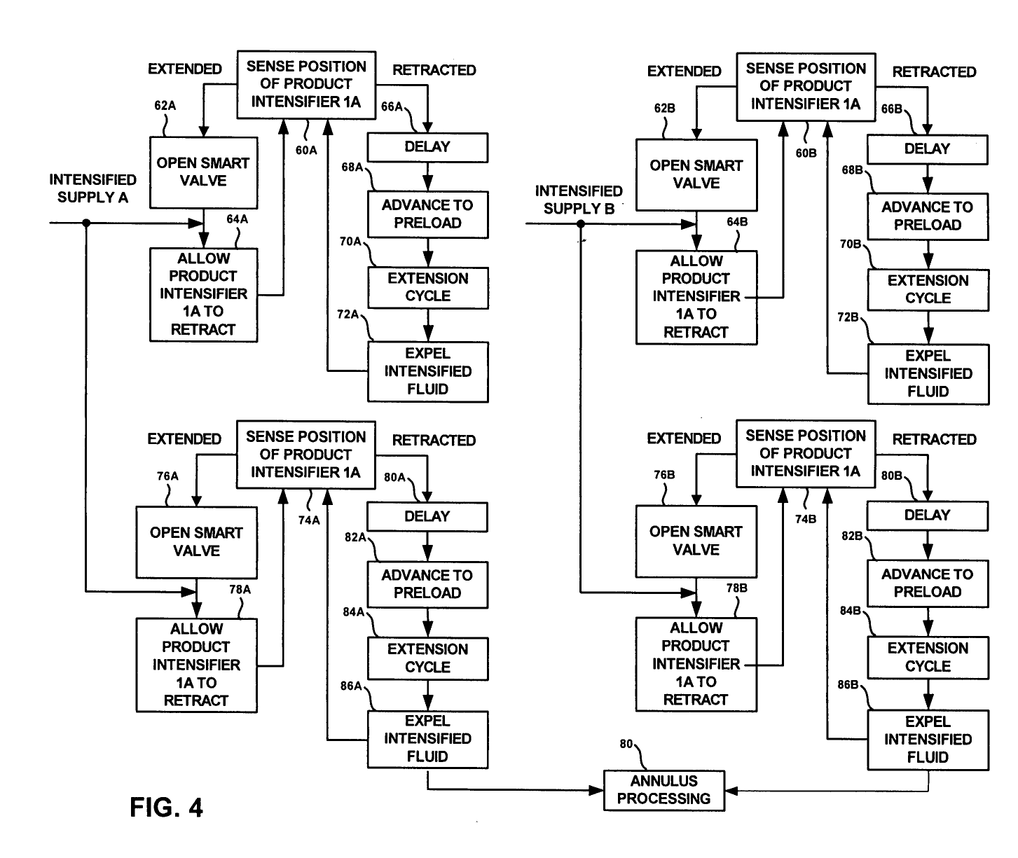

FIG. 4 is a flow diagram illustrating the operation of dual product intensifier sub-systems in the system 10 of FIGS. 1 and 2. As shown in FIG. 4, controller senses the positions of pistons associated with product intensifier pump 22A, 24A, 22B, 24B (60A, 74A, 60B, 74B, respectively) via respective sensors 36C-36F. When a respective piston is fully extended, controller 12 opens a respective smart valve (62A, 76A, 62B, 76B), allowing the piston in the product intensifier pump to receive intensified product fluid from charge intensifier pump 20A or 20B, and thereby retract (64A, 78A, 64B, 78B). It is to be understood that fully extended means that the piston is at or near the end of its advance cycle. This includes positions just prior to completing a full advance stroke, completing the full advance stroke, and the initial period of retraction just after completing a full advance stroke. The exact position at which the sensor will indicate that the piston is fully extended will depend upon the desired operating parameters of the system.

When controller 12 senses that the piston in a respective product intensifier pump 22A, 24A, 22B, 24B is retracted, the controller waits to a delay period so that the piston remains retracted for a short period of time to support pre-loading (66A, 80A, 66B, 80B). Thus, as the respective charge intensifier pump 20A, 20B continues to deliver material to the respective product intensifier pump 22A, 24A, 22B, 24B, the pressure within the respective intensifier barrel 35C-35F increases, providing pre-loading. Alternatively, smart valves 30C-30F remains open until a predetermined pressure is measured, rather than waiting for a predetermined delay period.

Controller 12 then controls pump 29 or 31, as applicable, to deliver hydraulic fluid to the respective working barrel 33C-33F, and thereby advances the piston to a preload position (68A, 82A, 68B, 82B). The piston then enters an extension cycle (70A, 84A, 70B, 84B) to advance the piston and thereby expel the intensified product fluid (72A, 86A, 72B, 86B) for delivery to fluid processing device 28. Charge intensifier pumps 22A, 24A generally perform the same functions, but at different times so that the two product intensifier pistons work together to achieve a smooth and continuous product outflow. Charge intensifier pumps 22B, 24B work in a similar manner. The process continues indefinitely under control of controller 12 until a desired amount of the two or more fluids has been delivered to fluid processing device 28.

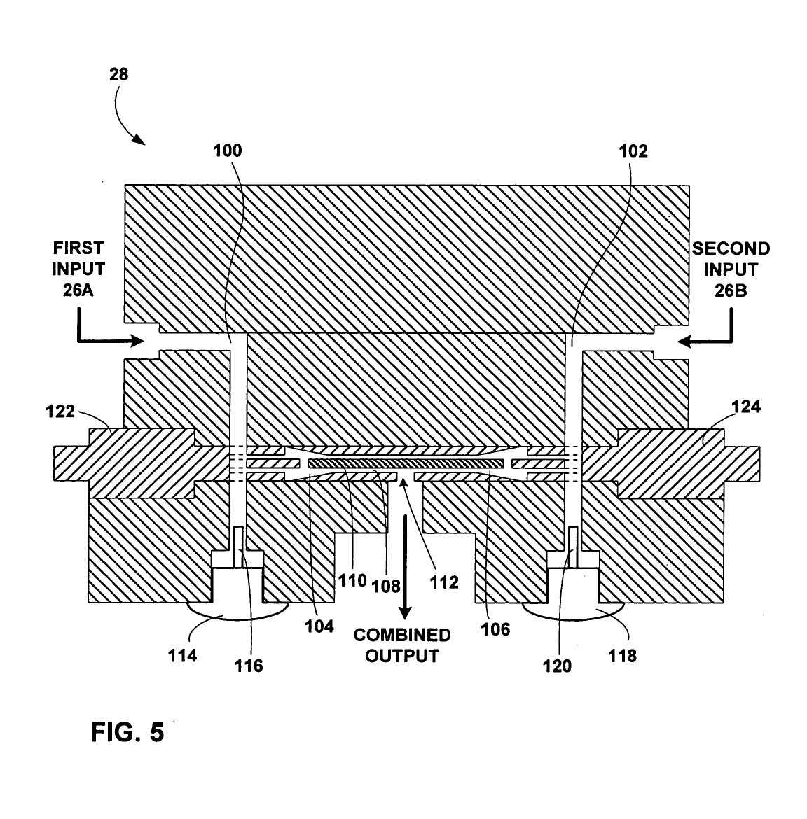

Exemplary characteristics of fluid processing device 28 will now be described with reference to FIG. 5. FIG. 5 is a cross-sectional diagram of a fluid processing device 28 having an annular fluid flow channel for use with the system 10 of FIGS. 1 and 2. The fluid processing device 28 of FIG. 5 is an example of a multiple fluid product stream processing device suitable for use with system 10. Fluid processing device 28 may be similar to the device described in U.S. Pat. No. 6,923,213, the entire content of which is incorporated in this disclosure by reference.

Fluid processing device 28 may be designed to handle pressurized fluids from intensifier system 10, at a pressure up to or greater than approximately 40,000 psi (275 MPa). The first fluid from system 10 enters processing device 28 through first input 26A, and the second fluid from system 10 enters the device through second input 26B. The first fluid is contained within flow channel 100 while the second fluid is contained within flow channel 102. Flow channels 100, 102 feed into opposing annular flow channels 104, 106, respectively, of a flow path cylinder 108, which defines an annular flow channel for the first and second fluids.

The inner diameter of flow path cylinder 108 defines an outer diameter of annular flow channels 104, 106 that feed toward one another to meet at the center of cylinder 108. Rod 110 is positioned inside flow path cylinder 108, and defines first and second ends. A first end of rod 110 extends into annular flow channel 104 and a second end of rod 110 extends into second annular flow channel 106. Ordinarily, rod 110 may be concentric with the annular flow channels 104, 106, having a center axis that is aligned with the central longitudinal axis of flow path cylinder 108. The outer diameter of rod 110 defines the inner diameter of annular flow channels 104, 106. Accordingly, flow channels 100 and 102 respectively feed into annular flow channels 104 and 106 defined by flow path cylinder 108 and rod 110. In some embodiments, the various flow paths and channels within device 28 may be machined using a common block of material.

The first fluid flows along annular flow channel 104, e.g., from left to right in FIG. 5, while the second fluid flows along annular flow channel 106, e.g., from right to left in FIG. 5. The two fluids collide at or near outlet 112 formed in flow path cylinder 108, e.g., approximately at the lateral center of cylinder 108. Outlet 112 is ported through the wall of cylinder 108 at the midpoint along the length of the cylinder. The energy dissipation from the shear and extensional forces of the collision of the two fluids flowing along annular flow channels 104 and 106 causes a reduction in size of the dispersed phase or phases. For example, agglomerations in each fluid can be broken up into smaller sized particles.

Additionally, the first fluid and the second fluid are mixed, reacted or combined to form a newly combined final fluid product. Moreover, annular flow channels 104 and 106 may enhance wall shear forces in fluid processing device 28 by increasing surface area associated with flow channels 104 and 106. In this manner, fluid processing device 28 may be used to reduce the size dispersed phase, such as particles, in each of the two fluids. The final fluid product is expelled through outlet 112 and exits fluid processing device 28 via an output line.

In some embodiments, high pressure fluid may be heated through a heater or cooled down from the intensifying process within intensifier system 10 by a heat exchanger (not shown) prior to entering processing device 28. Fluid processing device 28 may include pressure sensors 114 and 118 to measure the pressure of each fluid within fluid processing device 28, as well as temperature sensors 116 and 120 to measure the input temperatures of the first and second fluids. In a chemical reaction case, for example, another temperature sensor at output 112 may also be included (not shown). Sensors 116 and 120 may comprise thermocouples, thermistors, or the like. In some embodiments, temperature sensors 116 and 120 may be located at different positions within fluid processing device 28.

Controller 12 may receive the pressure measurement and adjust the pressure of the fluids at first and second inputs 26A, 26B via one or more regulator valves to maintain a desired pressure within fluid processing device 28. Alternatively, the controller may adjust the pressure of charge intensifier pumps 20A, 20B and/or both product intensifiers 22A, 24A and 22B, 24B. Similarly, the controller 12 may receive temperature measurements, and cause adjustment of the temperature to one or more fluids, as needed, by changing the heater and/or heat exchanger settings to maintain a desired input temperature for each fluid entering the fluid processing device 28 in response to a desired output temperature at output 112.

Substantially identical flows of each fluid down their respective annular flow channels 102, 104, e.g., in terms of pressure or temperature, are indicative of a non-clogged condition. Temperature monitoring, in particular, may be used to identify when a clogged condition occurs, and may be used to identify when anti-clogging measures should be taken, e.g., by application of a pulsated short term pressure increase in one or both input flows to clear the clog. For example, controller 12 may sense parameters such as temperature or pressure and control the pressure of the fluids delivered into the annular flow channels 104, 106 to unclog the flow channels.

Gland nuts 122 and 124 may be used to secure flow path cylinder 108 in the proper location within fluid processing device 28. Gland nuts 122 and 124 may be formed with channels (indicated by dotted lines in FIG. 5) that allow fluid to flow freely through flow channels 100, 102 and into annular flow channels 104, 106, respectively. Rod 110 may be cylindrically shaped, although the disclosure is not necessarily limited in that respect. For example, other shapes of rod 110 may further enhance wall shear forces in the annular flow channels. Alternative shapes may include a circular cylinder, oval cylinder or polygon cylinder.

Rod 110 may be free to move and vibrate within the flow path cylinder 108. In particular, rod 110 may be unsupported within flow path cylinder 108. Free movement of rod 110 relative to flow path cylinder 108 may provide an automatic anti-clogging action to fluid processing device 28. If dispersed phase, such as particles or agglomerations, in one or both of the fluids become clogged inside fluid processing device 28, e.g., at the edges of annular flow channels 104 or 106, rod 110 may respond to local pressure imbalances by moving or vibrating.

For example, a clog within cylinder 110 or in proximity of annular flow channels 104 or 106 may result in a local pressure imbalance that causes rod 110 to move or vibrate. The movement and/or vibration of rod 110, in turn, may help to clear the clog and return the pressure balance within fluid processing device 28. In this manner, allowing rod 110 to be free to move and vibrate within the flow path cylinder 108 can facilitate automatic clog removal. In other embodiments, rod 110 may be fixed within fluid processing device 37. For example, rod 110 may be supported by struts, bearings, or the like.

To further improve clog removal, or permit clog removal when rod 110 is fixedly mounted, a pulsated short term pressure increase in the input flow at first input 26A, second input 26B or both can be performed upon identifying a clog. For example, as mentioned above, temperature sensors 116, 120, and a temperature sensor (not shown) at output 112 may identify temperature changes in flow channels 100, 102, which may be indicative of a clogged condition. In response, controller 12 may control pumps or smart valves in system 10 to apply a short term pressure increase, e.g., a two-fold pressure increase for approximately a five-second duration, which may cause more substantial movement and/or vibration of rod 110 to facilitate clog removal.

The pulsated short term pressure increase in one or both input flows may be performed in response to identifying a clogged condition, or on a periodic basis. For example, product intensifier pumps 22A, 24A, 22B, 24B and/or both charge intensifier pumps 20A, 20B may be controlled by controller 12 to adjust the input pressure of the respective first or second fluids to fluid processing device 28. Alternatively, controller 12 may control inlet valves associated with device 28 the first and second fluids to selectively increase or decrease pressure and thereby unclog device 28. A short term pressure increase may be particularly useful in clearing clogs that affect both annular flow channels 104 and 106 In that case, the temperature of both input flow paths may be similar, but may increase because of the clog that affects both annular flow channels 104, 106.

In different embodiments, outlet 112 may have a fixed or adjustable size. For example, outlet 112 may take the form of a gap with an adjustable width. Flow path cylinder 108 and rod 110 may define substantially constant diameters. The components of fluid processing device 28, including flow path cylinder 108 and rod 110 may be formed of a hard durable metallic material such as steel or a carbide material. As one example, flow path cylinder 108 and rod 110 may be formed of tungsten carbide containing approximately six percent tungsten by weight;

Various embodiments of the invention have been described. Although this disclosure generally describes an intensifier and processing system designed to accommodate two different fluid products, in other embodiments, the system may be adapted for multiple product streams, e.g., two, three or more fluid products. In particular, an intensifier sub-system as described herein may be replicated to provide an additional fluid product stream into a fluid processing device. In such an embodiment, two, three or more different product fluids may be directed at one another to achieve mixing, reaction, or combination of the fluids. These and other embodiments are within the scope of the following claims.

1. A system comprising:
a first intensifier sub-system comprising a first charge intensifier pump, a first product intensifier pump that receives a first fluid from the first charge intensifier pump via a first controllable valve, a second product intensifier pump that receives the first fluid from the first charge intensifier pump via a second controllable valve;
a second intensifier sub-system comprising a second charge intensifier pump, a third product intensifier pump that receives a first fluid from the first charge intensifier pump via a third controllable valve, a fourth product intensifier pump that receives the first fluid from the first charge intensifier pump via a fourth controllable valve;
a controller that controls the controllable valves based on positions of pistons associated with the product intensifier pumps such that each of the controllable valves is open when the piston associated with the respective product intensifier pump is near an end of an extension cycle and closed when the piston associated with the respective product intensifier pump is at an end of a retraction cycle; and
a fluid processing device having a first input that receives the first fluid from the first and second product intensifier pumps, a second input receives the second fluid from the third and fourth product intensifier pumps, and an output that delivers a combined product of the first and second fluids.

2. The system of claim 1, wherein the fluid processing device further comprises:
a first annular flow channel coupled to the first input that delivers the first fluid in a first direction; and
a second annular flow channel coupled to the second input channel that delivers the second fluid in a second direction opposing the first direction such that the first and second fluid collides and combine with one another.

3. The system of claim 2, wherein the fluid processing device further comprises a flow path cylinder that defines an outer diameter of the first and second annular flow channels, the outlet being formed in the flow path cylinder, and a rod, positioned within the flow path cylinder, that defines an inner diameter of the first and second annular flow channels.

4. The system of claim 1, further comprising a plurality of position sensors, each of the position sensors sensing the position of one of the pistons associated with one of the product intensifier pumps.

5. The system of claim 1, further comprising a first hydraulic fluid pump that delivers hydraulic fluid to actuate the pistons in the first and second charge intensifier pumps.

6. The system of claim 5, further comprising a second hydraulic fluid pump that delivers hydraulic fluid to actuate the pistons in the first and second product intensifier pumps, and a third hydraulic fluid pump that delivers hydraulic fluid to actuate the pistons in the third and fourth intensifier pumps.

7. The system of claim 6, further comprising an electric motor that powers each of the first, second and third hydraulic pumps.

8. The system of claim 1, wherein the first and second charge intensifier pumps deliver the respective first and second fluids at a pressure level in a range of approximately 800 to 1700 pounds per square inch (psi).

9. The system of claim 8, wherein the product intensifier pumps deliver the respective first and second fluids at a pressure level in a range of approximately 5,500 to 40,000 psi.

10. The system of claim 1, wherein the controller controls the controllable valves and one or more hydraulic pumps such that the first and second product intensifier pumps operate at least partially out of phase with one another, and such that the third and fourth product intensifier pumps operate at least partially out of phase with one another.

11. The system of claim 1, wherein the first product intensifier pump retracts while the second product intensifier pump advances, and the third product intensifier pump retracts while the second product intensifier pump advances.

12. The system of claim 11, wherein the controller controls the hydraulic pumps and the controllable valves so that the first product intensifier pump is near an end of the extension cycle when the second product intensifier pump is near an end of the retraction cycle, and so that the third product intensifier pump is near an end of the extension cycle when the fourth product intensifier pump is near an end of the extension cycle.

13. The system of claim 1, wherein the first and second product intensifier pumps have extension cycles that at least partially overlap, and wherein the third and fourth product intensifier pumps have extension cycles that at least partially overlap.

14. The system of claim 1, further comprising a first reservoir containing a supply of the first fluid, and a second reservoir containing a supply of the second fluid, wherein the first and second fluids are different.

15. The system of claim 14, wherein the first and second fluids are selected from the group consisting of dissimilar liquids and liquid/solid mixtures.

16. A method comprising:
intensifying a first fluid via a first intensifier sub-system comprising a first charge intensifier pump, a first product intensifier pump that receives a first fluid from the first charge intensifier pump via a first controllable valve, a second product intensifier pump that receives the first fluid from the first charge intensifier pump via a second controllable valve;
intensifying a second fluid via a second intensifier sub-system comprising a second charge intensifier pump, a third product intensifier pump that receives a first fluid from the first charge intensifier pump via a third controllable valve, a fourth product intensifier pump that receives the first fluid from the first charge intensifier pump via a fourth controllable valve;
controlling the controllable valves based on positions of pistons associated with the product intensifier pumps such that each of the controllable valves is open when the piston associated with the respective product intensifier pump is near an end of an extension cycle and closed when the piston associated with the respective product intensifier pump is at an end of a retraction cycle; and
processing the first and second fluids in a fluid processing device having a first input that receives the first fluid from the first and second product intensifier pumps, a second input receives the second fluid from the third and fourth product intensifier pumps, and an output that delivers a combined product of the first and second fluids.

17. The method of claim 1, wherein the fluid processing device further comprises:
a first annular flow channel coupled to the first input that delivers the first fluid in a first direction; and
a second annular flow channel coupled to the second input channel that delivers the second fluid in a second direction opposing the first direction such that the first and second fluid collide and combine with one another.

18. The method of claim 17, wherein the fluid processing device further comprises a flow path cylinder that defines an outer diameter of the first and second annular flow channels, the outlet being formed in the flow path cylinder, and a rod, positioned within the flow path cylinder, that defines an inner diameter of the first and second annular flow channels.

19. The method of claim 16, further comprising sensing the position of one of the pistons associated with one of the product intensifier pumps.

20. The method of claim 16, further comprising delivering hydraulic fluid via a first hydraulic pump to actuate the pistons in the first and second charge intensifier pumps.

21. The method of claim 20, further comprising delivering hydraulic fluid via a second hydraulic pump to actuate the pistons in the first and second product intensifier pumps, and delivering hydraulic fluid via a third hydraulic pump to actuate the pistons in the third and fourth intensifier pumps.

22. The method of claim 21, further comprising using a single electric motor to power all of the first, second and third hydraulic pumps.

23. The method of claim 16, wherein the first and second charge intensifier pumps deliver the respective first and second fluids at a pressure level in a range of approximately 800 to 1700 pounds per square inch (psi).

24. The method of claim 23, wherein the product intensifier pumps deliver the respective first and second fluids at a pressure level in a range of approximately 5,500 to 40,000 psi.

25. The method of claim 16, further comprising controlling the controllable valves and one or more hydraulic pumps such that the first and second product intensifier pumps operate at least partially out of phase with one another, and such that the third and fourth product intensifier pumps operate at least partially out of phase with one another.

26. The method of claim 16, wherein the first product intensifier pump retracts while the second product intensifier pump advances, and the third product intensifier pump retracts while the second product intensifier pump advances.

27. The method of claim 26, further comprising controlling the hydraulic pumps and the controllable valves so that the first product intensifier pump is near an end of the extension cycle when the second product intensifier pump is near an end of the retraction cycle, and so that the third product intensifier pump is near an end of the extension cycle when the fourth product intensifier pump is near an end of the extension cycle.

28. The method of claim 16, wherein the first and second product intensifier pumps have extension cycles that at least partially overlap, and wherein the third and fourth product intensifier pumps have extension cycles that at least partially overlap.

29. The method of claim 1, further comprising supplying the first fluid from a first reservoir, and supplying the second fluid from a second reservoir, wherein the first and second fluids are different.

30. The method of claim 29, wherein the first and second fluids are selected from the group consisting of dissimilar liquids and liquid/solid mixtures.
